(19) United States
(12) Patent Application Publication
(10) Pub. No.: US 2021/0380484 A1
(43) Pub. Date: Dec. 9, 2021

(54) BORON-FREE ANTI-SAGGING ADDITIVE FOR GYPSUM BUILDING MATERIALS

(71) Applicant: KNAUF GIPS KG, Iphofen (DE)

(72) Inventors: Bernd PIETSCHMANN, Iphofen (DE); Michael STEINBAUER, Rottendorf (DE); David WEIGAND, Ochsenfurt (DE); Verena KOHLER, Scheinfeld (DE); Juliane KÖHLER, Weißenbach bei Liezen (AT)

(21) Appl. No.: 17/287,011

(22) PCT Filed: Oct. 26, 2018
(86) PCT No.: PCT/EP2018/000492

§ 371 Date: Apr. 20, 2021

(51) Int. Cl. C04B 28/14; C04B 7/02; C04B 24/06

(52) U.S. Cl. CPC C04B 28/14; C04B 2111/00094; C04B 24/06; C04B 7/02

(57) ABSTRACT

The invention concerns an anti-sagging additive for producing shaped gypsum articles. The additive is boron-free and comprises L-tartaric acid and/or L-tartrates and a pH-enhancing compound.

The invention relates to an anti-sagging additive for gypsum building materials. In particular, the invention relates to an additive for gypsum building materials which increases the sag resistance of gypsum building materials and which is boron-free.

Additives which increase the sag resistance of shaped gypsum articles, in particular gypsum boards, are known from the prior art. The phenomenon of creep in the case of gypsum boards, in particular when exposed to warm and humid conditions, has long been known. By way of example, DE 17 71 017 B2 describes the use of tartaric acid to reduce the creep of shaped gypsum articles. Better results are attained with polyphosphates, in particular with STMP (sodium tri-metaphosphate), see for example WO 99/08978.

In addition, combinations of different reagents are known from the prior art. US 2006/0048680 A1 for example describes the use of a combination of tartaric acid with boric acid or borates as an additive for improving sag resistance. In addition, alkali metal phosphates or alkaline earth metal phosphates, for example STMP, can also be contained.

WO 2017/092837 A1 describes an anti-sagging additive comprising boric acid and/or salts of boric acid, tartaric acid and/or salts of tartaric acid, and cement.

Recently, the industrial use of boron-containing reagents is the subject of ongoing discussions because severe health hazards cannot be ruled out. Safety regulations, for example the European REACh regulation, might in future prevent or strongly limit the use of these compounds. Thus, boron-free additives are needed.

The object of the invention is to provide a further additive for improving the sag resistance of shaped gypsum articles, which does not contain STMP or boric acid or borates. In addition, shaped gypsum articles and also a method for producing shaped gypsum articles of this type will be provided, wherein said gypsum articles do not contain any STMP nor boric acid or borates.

The object is achieved by means of an anti-sagging additive according to claim 1, a shaped gypsum article according to claim 6, and a method for producing a shaped gypsum article according to claim 7. Features of advantageous embodiments of the invention are described in the respective dependent claims.

The word “additive” is used as an encompassing term for the constituents of a gypsum slurry which positively influence the sag resistance of the finished shaped gypsum article. The additive does not necessarily have to be a prefabricated mixture, and instead the individual constituents can also be added individually to a gypsum slurry.

A shaped gypsum article is an article with a defined form made primarily from gypsum, i.e. having a gypsum content of more than 50 wt.-%, preferably of more than 85 wt.-%. The shaped gypsum article is preferably a plasterboard.

An anti-sagging agent is a composition which, if comprised in a shaped gypsum article, reduces or prevents sagging of that article, i.e. the creeping of gypsum, meaning a plastic deformation due to load acting on the shaped gypsum article. The load can be any force acting on the article, for example the gravitational force.

An anti-sagging additive for the production of shaped gypsum articles is a compound for use in the production of shaped gypsum articles as an anti-sagging agent.

Accordingly, an anti-sagging additive for producing shaped gypsum articles comprises L-tartaric acid (Levotartaric acid) and/or L-tartrates and a pH-enhancing compound but no boron-containing compounds as for example boric acid or borates. The additive is basically boron-free, i.e. no boron-containing compounds are actively added. Preferably, also the slurry in which the anti-sagging additive is used is basically boron-free. The pH-enhancing compound can preferably be a cement, especially a Portland cement. However, other pH-enhancing substances can also be used, for example quicklime or white cement.

Preferably, the additive contains an amount of L-tartaric acid/L-tartrate and an amount of pH-enhancing compound (cement) in a ratio (with reference to the mass) from 1:1 to 1:10, preferably from 1:2 to 1:5.

The L-tartaric acid and/or the salts of L-tartaric acid (L-tartrates) is contained in the additive in quantities of from 0.001 to 0.1% by weight, preferably from 0.01 to 0.05% by weight in relation to the mass of calcined gypsum in which it is used.

By way of example, a Portland cement can be used as a pH-enhancing compound. In accordance with one embodiment of the invention, the cement is contained in a quantity of from 0.05 to 0.5% by weight, preferably 0.08 to 0.25% by weight, in relation to the mass of calcined gypsum in which the additive is used.

The invention also relates to shaped gypsum articles, in particular gypsum boards such as plasterboards, which have been produced from a slurry consisting at least of calcined gypsum, water, and an anti-sagging additive for producing shaped gypsum articles from set gypsum. The anti-sagging additive comprises or contains the above-described substances, specifically tartaric acid and/or tartrates and a pH-enhancing compound but no boron-containing compounds.

The invention additionally relates to a method for producing a shaped gypsum article, in particular a gypsum board, comprising the steps of mixing calcined gypsum with water and an anti-sagging additive, forming a shaped gypsum article and optionally drying the shaped gypsum article to produce shaped gypsum articles from set gypsum. The additive contains the above-described constituents, specifically tartaric acid and/or tartrates and a pH-enhancing compound but no boron-containing compounds.

The invention will be explained in greater detail hereinafter on the basis of exemplary embodiments.

Conveyor line tests were carried out with differently composed additives for improving the sag resistance of plasterboards. The produced plasterboards consist of a foamed gypsum core, which is encased by a paperboard web. The boards are conventionally produced, i.e. firstly a slurry is made from beta-hemihydrate, water, the corresponding anti-sagging additive, and further additives, in particular an accelerator and a foamed surfactant solution. Since tartaric acid has the effect of delaying the setting rate of the gypsum slurry, the added quantity of accelerator was set such that approximately constant setting times were obtained for the different slurries. A fine-grained, i.e. powdered potassium sulphate dihydrate was used as accelerator. The selection of the accelerator is not critical within the scope of the invention, and therefore other accelerators with which a person skilled in the art is familiar can also be used.

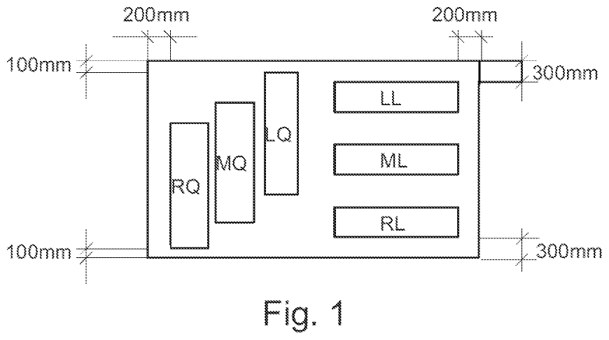

In order to determine the sag of the produced plasterboards, samples measuring 10 cm×67 cm were cut out from the plasterboards at predefined points, see FIG. 1, of the board. Three longitudinal samples (RL=right longitudinal, ML=middle longitudinal and LL=left longitudinal) and three transversal samples (RQ=right transverse, MQ=middle transverse and LQ=left transverse) were taken per examined board. The longitudinal samples were cut out from the examined boards such that their longitudinal extent ran in the production direction of the boards. The transverse samples were cut out from the examined boards such that their longitudinal extent was arranged perpendicularly to the production direction of the boards. One sample in each case (ML, MQ) was taken from the middle of the board, i.e. with equal distance from the two longitudinal edges of the board, and one sample in each case (LL, LQ and RL, RQ) was taken from a board region arranged closer to the left or right board edge respectively.

The samples thus removed were then dried, standing on their longitudinal edge, in a drying cabinet until a constant weight was reached, and the zero value for the sag determination (starting sag) was determined by means of a precision depth gauge in the middle of the sample.

The samples were stored, supported at the edge (distance between the supports: 60 cm), in a climate chamber at 20+/−1° C. and 90+/−1% relative humidity for 7 days. The sag was then determined again in the manner described above, and the absolute value was determined by subtracting the starting sag. The values of the three longitudinal samples and the values of the three transverse samples per board were averaged in each case.

Table 1 lists determined sag values. The boards tested were produced on different days so that 4 groups of samples can be distinguished: V15 to V19, V20 to V26, V27 to V33, and V34 to V39. For each sample replicates were cut from two plasterboards, and the replicates were tested for sag in different runs. Each run starts with tests performed on boards produced with the internal “standard” anti-sagging additive, i.e. with 0.03 wt.-% STMP, 0.1 wt.-% cement, and 0.05 wt.-% boric acid each relating to the mass of stucco used to produce the respective boards. To the right of the “standard column” the columns show runs with differently composed anti-sagging additives, the contents of which are indicated. DL- or L-tartaric acid were used in an amount of 0.03 wt.-%; boric acid was used in an amount of 0.05 wt.-%, and cement was always used in an amount of 0.1 wt.-%, all amounts referring the amount of stucco used to produce the respective board.

The abbreviations “long. 1” and “trans. 1” refer to longitudinal and transversal samples (see above) of the first run. “Long. 2” and “trans. 2” refer to the longitudinal and transversal samples of the second run. Below the individual measurements, the two measurements for each sample were averaged as “0 long.” or “0 trans.”. “00 long” and “00 trans.” denote the arithmetic mean of all longitudinal samples or all transversal samples of the test, i.e. without distinguishing from which part of the board they were cut. The lowest line shows an average value for all measurements of one test.

All samples were prepared in the same manner and contained the same ingredients apart from the used anti-sagging additives.

The samples containing DL-tartaric acid, cement, and boric acid (V38) reveal on average a slightly lower sag than all the samples produced with the internal standard, i.e. STMP, cement and boric acid (V15, V20, V27, and V34). The only difference between the samples V38 and the standard samples is that STMP was replaced with equal amounts of DL-tartaric acid.

Very good results in terms of sag are achieved if STMP is replaced with L-tartaric acid (V26, V36) and boric acid is contained in the samples.

However, if boric acid is omitted (samples V19 and V39) due health and environment issues another picture presents itself. Sag values containing DL-tartaric acid instead of STMP but no boric acid show clearly higher sags than the respective standard samples (V15 and V34).

Surprisingly, using L-tartaric acid instead of DL-tartaric acid and cement but no boric acid (V25, V33, V37) reveals sag values clearly lower than the standard.

Thus, a replacement of the internal standard with a combination of tartaric acid and cement, omitting boric acid is possible without quality deterioration.

| | | | V16 | V19 | | V21 | V25 | V26 | | V28 |
|---|---|---|---|---|---|---|---|---|---|---|
| | | V15 | without any | DL-tartaric | V20 | without any | L-tartaric | L-tartaric | V27 | without any |
| | direction | standard | additives | acid, cement | standard | additives | acid [symbol] | acid, [symbol] | standard | [symbol] |
| long. 1 | RL1 | 2.46 | 6.84 | 3.35 | 2.82 | 6.45 | 1.90 | 1.80 | 2.39 | 3.74 |
| | ML1 | 2.37 | 6.37 | 3.57 | 2.88 | 6.81 | 1.72 | 1.84 | 2.34 | 3.71 |
| | LL1 | 2.44 | 6.28 | 3.53 | 3.07 | 6.34 | 2.04 | 2.11 | 2.37 | 3.49 |
| trans. 1 | RQ1 | 2.38 | 6.36 | 3.88 | 3.01 | 6.71 | 2.24 | 1.40 | 2.89 | 4.19 |
| | MQ1 | 2.52 | 8.03 | 3.33 | 2.98 | 7.16 | 2.02 | 1.48 | 2.88 | 4.43 |
| | LQ1 | 2.59 | 5.79 | 3.47 | 3.16 | 7.08 | 2.19 | 1.42 | 2.86 | 4.56 |
| long. 2 | RL2 | 2.54 | 6.30 | 3.59 | 2.72 | 5.85 | 2.64 | 1.86 | — | — |
| | ML2 | 2.46 | 6.50 | 3.59 | 2.87 | 5.99 | 2.26 | 1.70 | — | — |
| | LL2 | 2.56 | 6.23 | 3.45 | 3.18 | 6.21 | 2.58 | 1.67 | — | — |
| trans. 2 | RQ2 | 2.46 | 6.67 | 3.33 | 2.90 | 7.48 | 1.73 | 1.47 | — | — |
| | MQ2 | 2.54 | 6.73 | 3.32 | 3.03 | 7.75 | 1.49 | 1.44 | — | — |
| | LQ2 | 2.60 | 7.24 | 3.29 | 2.87 | 7.78 | 1.66 | 1.39 | — | — |
| Ø long. | RL | 2.50 | 6.57 | 3.47 | 2.77 | 6.15 | 2.27 | 1.83 | 2.39 | 3.74 |
| | ML | 2.42 | 6.44 | 3.58 | 2.88 | 6.40 | 1.99 | 1.77 | 2.34 | 3.71 |
| | LL | 2.50 | 6.26 | 3.49 | 3.13 | 6.28 | 2.31 | 1.89 | 2.37 | 3.49 |
| Ø trans. | RQ | 2.42 | 6.52 | 3.61 | 2.96 | 7.10 | 1.99 | 1.44 | 2.89 | 4.19 |
| | MQ | 2.53 | 7.38 | 3.33 | 3.01 | 7.46 | 1.76 | 1.46 | 2.88 | 4.43 |
| | LQ | 2.60 | 6.52 | 3.38 | 3.02 | 7.43 | 1.93 | 1.41 | 2.86 | 4.56 |

| | | | | | | | | | |
|---|---|---|---|---|---|---|---|---|---|
| ØØ long. | 2.47 | 6.42 | 3.51 | 2.92 | 6.28 | 2.19 | 1.83 | 2.37 | 3.65 |
| ØØ trans. | 2.52 | 6.80 | 3.44 | 2.99 | 7.33 | 1.89 | 1.43 | 2.88 | 4.39 |
| average | 2.49 | 6.61 | 3.48 | 2.96 | 6.80 | 2.04 | 1.63 | 2.63 | 4.02 |

| | | V33 | | V35 | V36 | V37 | V38 | V39 |
|---|---|---|---|---|---|---|---|---|
| | | L-tartaric | V34 | without any | L-tartaric | L-tartaric | DL-tartaric | DL-tartaric |
| | direction | acid, cement | standard | additives | acid, cement, [symbol] | acid [symbol] | acid, [symbol] | acid, [symbol] |
| long. 1 | RL1 | 2.22 | 2.67 | 5.77 | 2.21 | 2.29 | 1.98 | 2.92 |
| | ML1 | 2.01 | 2.72 | 5.86 | 1.92 | 2.23 | 1.86 | 2.83 |
| | LL1 | 2.10 | 2.76 | 5.34 | 1.96 | 2.28 | 1.90 | 2.82 |
| trans. 1 | RQ1 | 1.92 | 2.80 | 6.75 | 1.95 | 2.50 | 1.95 | 3.29 |
| | MQ1 | 1.89 | 2.99 | 6.97 | 1.96 | 2.55 | 1.77 | 3.22 |
| | LQ1 | 2.11 | 2.98 | 7.13 | 2.11 | 2.43 | 1.85 | 3.23 |
| long. 2 | RL2 | — | 2.83 | 5.25 | 2.16 | 2.15 | 1.96 | 3.33 |
| | ML2 | — | 2.81 | 5.47 | 1.73 | 2.14 | 1.97 | 3.28 |
| | LL2 | — | 2.80 | 5.01 | 1.83 | 2.23 | 1.86 | 3.32 |
| trans. 2 | RQ2 | — | 3.04 | 6.46 | 2.80 | 2.49 | 2.15 | 3.96 |
| | MQ2 | — | 3.10 | 6.74 | 2.08 | 2.55 | 1.94 | 3.99 |
| | LQ2 | — | 2.95 | 6.50 | 2.10 | 2.30 | 1.85 | 3.99 |
| Ø long. | RL | 2.22 | 2.75 | 5.51 | 2.19 | 2.22 | 1.97 | 3.13 |
| | ML | 2.01 | 2.77 | 5.67 | 1.83 | 2.19 | 1.92 | 3.06 |
| | LL | 2.10 | 2.78 | 5.18 | 1.90 | 2.26 | 1.88 | 3.07 |
| Ø trans. | RQ | 1.92 | 2.92 | 6.61 | 2.38 | 2.50 | 2.05 | 3.63 |
| | MQ | 1.89 | 3.05 | 6.86 | 2.02 | 2.55 | 1.86 | 3.61 |
| | LQ | 2.11 | 2.97 | 6.82 | 2.11 | 2.37 | 1.85 | 3.61 |

| | | | | | | | |
|---|---|---|---|---|---|---|---|
| ØØ long. | 2.11 | 2.77 | 5.45 | 1.97 | 2.22 | 1.92 | 3.08 |
| ØØ trans. | 1.97 | 2.98 | 6.76 | 2.17 | 2.47 | 1.92 | 3.61 |
| average | 2.04 | 2.87 | 6.10 | 2.07 | 2.35 | 1.92 | 3.35 |

[symbol]

indicates data missing or illegible when filed

1. An anti-sagging additive for producing shaped gypsum articles, comprising L-tartaric acid and/or L-tartrates and a pH-enhancing compound but no boron-containing compounds.

2. The anti-sagging additive according to claim 1, wherein the pH-enhancing compound is a cement.

3. The anti-sagging additive according to claim 1, wherein a ratio of an amount of L-tartaric acid or L-tartrate to an amount of pH-enhancing compound is from 1:1 to 1:10.

4-5. (canceled)

6. A shaped gypsum article produced at least from a slurry formed from calcined gypsum, water, and an anti-sagging additive, wherein the anti-sagging additive comprises L-tartaric acid and/or L-tartrates and a pH-enhancing compound but no boron compounds.

7. A method for producing a shaped gypsum articles comprising steps of mixing of calcined gypsum with water and an additive, wherein the additive comprises L-tartaric acid and/or L-tartrates and a pH-enhancing compound, and forming the shaped gypsum article.

8. The anti-sagging additive according to claim 3, wherein the ratio of the amount of the L-tartaric acid or the L-tartrate to the amount of the pH-enhancing compound is from 1:2 to 1:5.

9. The shaped gypsum article according to claim 6, wherein the L-tartaric acid and/or the L-tartrates is/are contained in a mass of from 0.001 to 0.1% by weight in relation to a mass of the calcined gypsum.

10. The shaped gypsum article according to claim 9, wherein the L-tartaric acid and/or the L-tartrates is/are contained in the mass of from 0.01 to 0.05% by weight in relation to the mass of the calcined gypsum.

11. The shaped gypsum article according to claim 6, wherein the pH-enhancing compound is contained in a quantity of from 0.05 to 0.5% by weight in relation to a mass of the calcined gypsum.

12. The shaped gypsum article according to claim 11, wherein the pH-enhancing compound is contained in the quantity of from 0.08 to 0.25% by weight in relation to the mass of the calcined gypsum.

13. The shaped gypsum article according to claim 6, wherein the shaped gypsum article is a gypsum board.

14. The method according to claim 7, wherein the shaped gypsum article is a gypsum board.

15. The method according to claim 7, wherein the method comprises the step of drying the shaped gypsum article.
